(19) United States
(12) Patent Application Publication
(10) Pub. No.: US 2003/0152125 A1
(43) Pub. Date: Aug. 14, 2003

(54) Surface emitting laser and semiconductor light emitting device

(76) Inventor: Junichi Kinoshita, Yokohama-Shi (JP)

Correspondence Address: Hogan & Hartson, LLP, Suite 1900, 500 South Grand Avenue, Los Angeles, CA, 90071, US

(21) Appl. No.: 10/076,698

(22) Filed: Feb. 13, 2002

(51) Int. Cl. H01S 3/08

(52) U.S. Cl. 372/96

(57) ABSTRACT

A surface emitting laser alleviated in reflection from facets of its active layer and waveguide layer and remarkably improved in oscillation property is configured not to make vertical side surfaces relative to the active layer or the waveguide direction. In VCSEL, side surfaces of the active layer are processed not to made vertical surfaces. In GCSEL, its crystalline surface orientation and its waveguide structure are chosen appropriately not to make upright surfaces on facets of the waveguide.

### BACKGROUND OF THE INVENTION

This invention relates to a surface emitting laser and semiconductor light emitting device and, more particularly, to those with a high performance ensuring very stable vertical oscillation and excellent single longitudinal mode oscillating property.

Surface emitting lasers are more advantageous than edge emitting semiconductor lasers in obtaining laser light beam with a narrow divergence. They are advantageous also from the manufacturing viewpoint because they do not need cleavage and therefore enable an as-wafer test. A vertical cavity surface emitting laser (VCSEL) is explained below as a first example of surface emitting lasers.

FIGS. 7A and 7B are a perspective view and a cross-sectional view schematically showing a structure of VCSEL experimentally fabricated by the Inventor during researches toward the present invention.

In VCSEL, HR-DBRs (high-reflectivity distributed Bragg reflectors) 100 (upper) and 200 (lower) of a layer-stack structure are provided on and under an active layer 3 having a MQW (multiple-quantum well) structure, forming a vertical resonant cavity. Laser output, thus obtained, is obtained from an opening of a top electrode 50.

A grating-coupled surface emitting laser (GCSEL) is next explained as a second example of surface emitting lasers.

FIG. 8 is a schematic diagram of GCSEL which was also experimentally fabricated by the Inventor during researches toward the present invention, which shows a cross-sectional structure of GCSEL using InGaAlP/GaAs material system. This laser is a kind of distributed feedback (DFB) lasers. A diffraction grating is provided along the waveguide structure, and Bragg diffraction from the grating is used for optical feedback. Because of wavelength selectivity in accordance with the period of the grating, DFB lasers are capable of oscillating in a single longitudinal mode. DFB lasers having 2nd-order gratings are capable of emitting radiation mode light normal to the waveguide direction. GCSEL is a light emitting device using the radiation mode as its output. This is a surface emitting device, and does not require cleaved facets perpendicular to the waveguide direction.

Construction of GCSEL shown in FIG. 8 is explained below following to its manufacturing process. An n-type cladding layer 2 of InGaAlP (Al ratio: 0.7) is first grown on an n-type GaAs substrate 1, and an active layer 3 of InGaP/InGaAlP MQW structure is grown successively. Further grown thereon are a cladding layer 4 of p-type InGaAlP (Al ratio: 0.7) and a waveguide layer 5 of p-type InGaAlP (Al ratio: 0.2).

Next made thereon are 2nd-order gratings 10 whose period is approximately 0.2 μm. Thereafter, a cladding layer of p-type InGaAlP (Al ratio: 0.7) and a current spreading layer 7 of p-type InGaP are grown.

Finally, an n-electrode 20 and a p-electrode 30 are made. On the p-side, a transparent electrode, ITO (indium tin oxide), is deposited. Radiation mode outputs from the gratings can be obtained through this transparent electrode.

In FIG. 8, a current constricting mechanism extending in a transverse direction, that is, vertically of the drawing sheet, is not illustrated.

As a result of own researches by the Inventor, any of these surface emitting lasers has been found to involve problems in connection with its property or manufacturing process.

A problem with VCSEL explained with reference to FIGS. 7A and 7B lies in that undesirable resonance R along the horizontal direction may occur in addition to the required oscillation vertical to the substrate surface. As shown in FIGS. 7A and 7B, in the conventional VCSEL, its side surface of the active layer is perpendicular to the active layer 3 itself. Therefore, light generated in the active layer 3 may be reflected at the side surface, and horizontal oscillation may occur. Thus, the conventional VCSEL involved the problem that horizontal oscillation might disturb vertical oscillation necessary for VCSEL.

In GCSEL shown in FIG. 8, if the devices are fabricated from wafers by grown on a precisely (100)-oriented substrate and cleaved out, cleaved facets 60 perpendicular to the waveguide are inevitably reveal themselves on cavity edges. A problem with GCSEL shown in FIG. 8 lies in that the guided light is reflected and fed back by the cleaved facets, and often produces a Fabry-Perot mode. In order to restrict the Fabry-Perot mode, reflectivity of the cleaved facets must be decreased. However, additional manufacturing procedures are required for coating an anti-reflection film to decrease the reflectivity of the cleaved facets. Moreover, the need for the anti-reflection processing is not desirable because the advantage of the surface emitting laser, “no edge required”, is lost.

### SUMMARY OF THE INVENTION

It is therefore an object of the invention to provide a surface emitting laser capable of preventing reflection at edges of its active layer and waveguide layer and thereby remarkably improving the oscillation property, and a semiconductor light emitting device incorporating such a surface emitting laser.

According to the invention, there is provided a surface emitting laser comprising:

a semiconductor substrate; and

an active layer made on a first major surface of the semiconductor substrate, so that light output emitted from the active layer in a direction substantially normal to the major surface of the substrate,

the active layer having side surfaces which are offset from vertical planes perpendicular to the major surface of the semiconductor substrate to prevent horizontal (or parallel) resonance of light in the active layer.

According to the invention there is further provided a surface emitting laser comprising:

a semiconductor substrate;

an active layer provided on a first major surface of the semiconductor substrate; and

a waveguide layer provided on the first major surface of the semiconductor substrate and having formed 2nd-order gratings along the waveguide direction, so as to output light in a direction substantially normal to the first major surface of said semiconductor substrate,

the laser having a substantially rectangular configuration when viewed from a direction vertical to the first major surface of the semiconductor substrate,

any of side surfaces of the substantially rectangular configuration being cleaved surfaces;

the cleaved surfaces being offset from vertical planes perpendicular to the first major surface,

the waveguide direction being not parallel with any of sides of the substantial rectangle.

The invention is used in the above-summarized modes, and attains the following effects. First, the invention realizes a VCSEL surface emitting laser suppressing a transverse Fabry-Perot mode.

In GCSEL using 2nd-order gratings, by slanting the waveguide direction from 45° relative to the cleaved surfaces, each chip area can be reduced, and more chips can be made from a single wafer.

In GCSEL using an off-axis substrate slanted toward the waveguide direction, 2nd-order gratings have a asymmetric cross-sectional configuration between left and right sides thereof in accordance with the inclination of the substrate. That is, they have a blaze angle. DFB lasers using 2nd-order gratings with a blaze angle are effective in forcibly stabilizing longitudinal modes as standing waves because there occurs effective gain/loss coupling. Therefore, they are advantageous for oscillation in single longitudinal modes. Additionally, a large coupling is obtained even with shallow gratings. Needless to say, since the cleaved facets are also slanted, reflection from facets can be decreased. Employment of an off-axis substrate by the invention facilitates realization of both a low reflection from edges and improvement in single longitudinal mode property.

When such an element is molded with a transparent material, an inexpensive, high-performance surface emitting laser element can be obtained.

### BRIEF DESCRIPTION OF THE DRAWINGS

The present invention will be understood more fully from the detailed description given herebelow and from the accompanying drawings of the preferred embodiments of the invention. However, the drawings are not intended to imply limitation of the invention to a specific embodiment, but are for explanation and understanding only.

In the drawings:

FIG. 1A is a perspective view schematically showing a surface emitting laser according to the first embodiment of the invention;

FIGS. 1B is a fragmentary cross-sectional view of a central part of the laser shown in FIG. 1A;

FIG. 2 is a cross-sectional view schematically showing a surface emitting laser according to the second embodiment of the invention;

FIG. 3 is a cross-sectional view schematically showing a surface emitting laser according to the third embodiment of the invention;

FIGS. 4A through 4D are diagrams schematically showing surface emitting lasers according to the fourth embodiment of the invention;

FIGS. 5A and 5B are diagrams schematically showing a surface emitting laser according to the fifth embodiment of the invention;

FIG. 6 is a diagram schematically showing a semiconductor light emitting device according to an embodiment of the invention;

FIG. 7A is a perspective view schematically showing construction of VCSEL experimentally made by the Inventor in the course toward the invention;

FIG. 7B is a cross-sectional view of a central part of VCSEL shown in FIG. 7A; and

FIG. 8 is a diagram schematically showing GCSEL experimentally made by the Inventor in the course toward the invention.

### DETAILED DESCRIPTION OF THE PREFERRED EMBODIMENTS

In surface emitting lasers, in general, side surfaces perpendicular to the waveguide direction of laser light may cause useless and undesirable resonance. To overcome this problem, the invention proposes various types of construction not making vertical side surfaces.

In a distributed feedback (DFB) laser using 2nd-order gratings along its waveguide, a radiation mode is emitted in a direction normal to the substrate surface. A laser using this radiation mode light as its output is a surface emitting laser. Both waveguide edges need not be normal to the waveguide direction because its output is not required to obtain from the edges. If the edges are normal, undesirable Fabry-Perot mode is introduced. VCSEL according to the invention is processed not to make vertical surfaces normal to the active layer on the all side planes of the active layer. In case of GCSEL according to the invention, crystalline planes and the waveguide structure are disposed not to make edge surfaces normal to the waveguide direction.

Embodiments of the invention are explained below in detail with reference to the drawings.

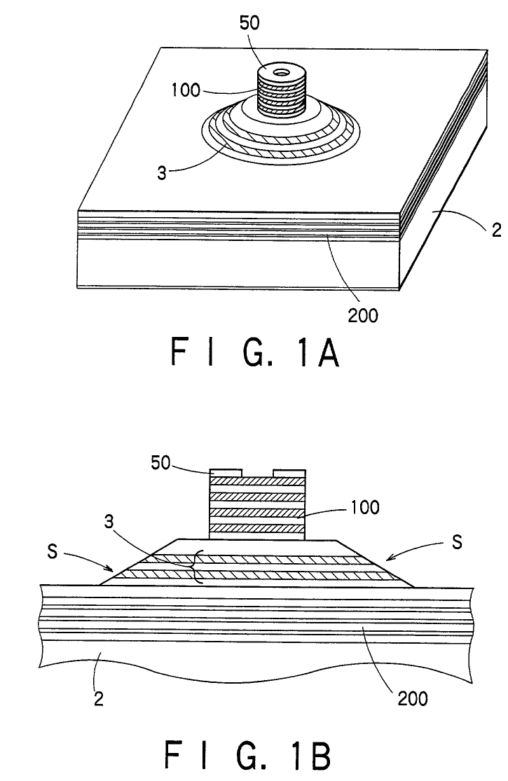

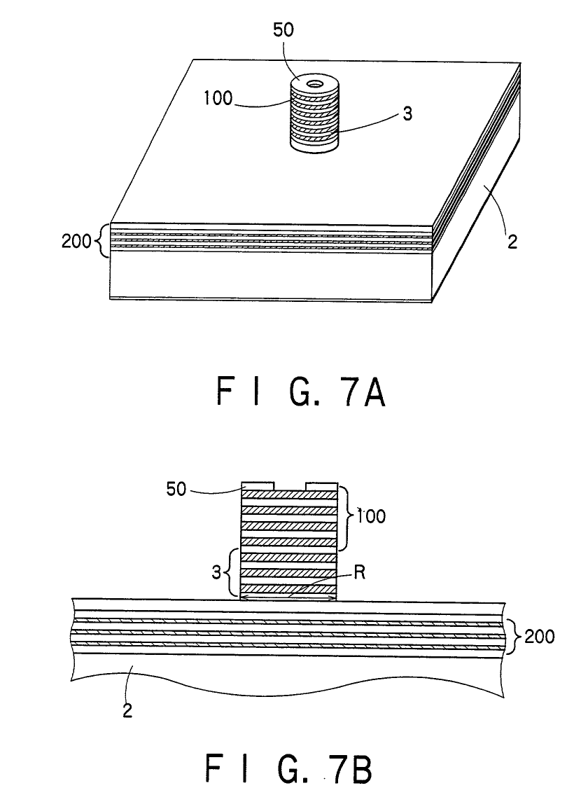

FIG. 1A is a perspective view schematically showing a surface emitting laser according to the first embodiment of the invention, and FIG. 1B is a cross-sectional view schematically showing its central part. The surface emitting laser shown here is an improved version of VCSEL explained above with reference to FIGS. 7A and 7B. That is, HR-DBRs (high-reflectivity distributed Bragg reflectors) 100 (lower and 200 (upper) of a high reflectivity layer structure are provided on and under an active layer having a MQW (multiple-quantum well) structure on a substrate 2 to make light from the active layer 3 resonate vertically. Laser light, thus obtained, is emitted externally from an opening of a top electrode 50.

In the present invention, side surfaces of the active layer 3 are not normal to the active layer 3, but they are processed to slant in directions gradually increasing their distance toward the substrate 2. With these slanted side surfaces, it is ensured to prevent undesirable horizontal resonance and invite vertical resonance alone. These slanted surfaces can be made by processing using HBr-based wet etchant, for example.

By configuring side surfaces of the active layer to be slanted surfaces, horizontal resonance caused by reflection of light by the side surfaces can be removed. As a result, only vertical resonance is excited, and stable oscillation is realized.

In the illustrated example, side surfaces of the active layer are processed to slant in directions gradually increasing their distance toward the substrate 2. However, they may be processed to the contrary, namely, to define slant surfaces gradually decreasing their distance toward the substrate.

Next explained is the second embodiment of the invention.

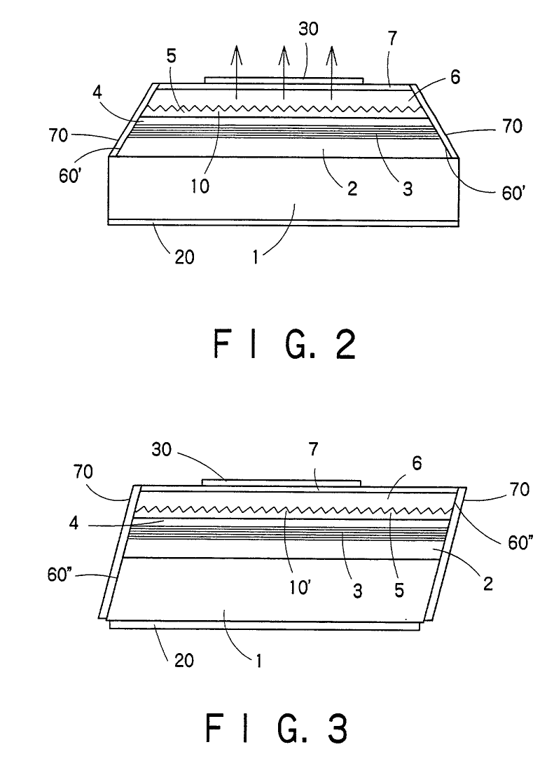

FIG. 2 is a cross-sectional view schematically showing a surface emitting laser according to the second embodiment of the invention. The laser shown here is an example in which the invention is applied to a InGaAlP/GaAs-based surface emitting DFB laser using 2nd-order gratings (GCSEL).

More specifically, the laser shown here includes an n-type cladding layer 2 made of InGaAlP (Al composition: 0.7), active layer 3 with a MQW structure of InGaP/InGaAlP, cladding layer 4 of p-type InGaAlP (Al composition: 0.7), and waveguide layer 5 of p-type InGaAlP (Al composition: 0.2) which are stacked in this order on an n-type GaAs substrate 1. 2nd-order gratings 10 are formed along the surface of the waveguide layer 5. Their period may be, for example, approximately 0.2 μm. Further stacked on the gratings 10 are a cladding layer 6 made of p-type InGaAlP (Al composition: 0.7) and a current spreading layer 7 made of p-type InGaP.

Additionally, an n-side electrode 20 and a p-side electrode 30 are made on and under the device. The p-side electrode may be made of ITO (indium tin oxide) having both an optical transmittance and an electric conductivity. Thus, radiation mode outputs can be obtained from the gratings 10 through the p-side electrode 30.

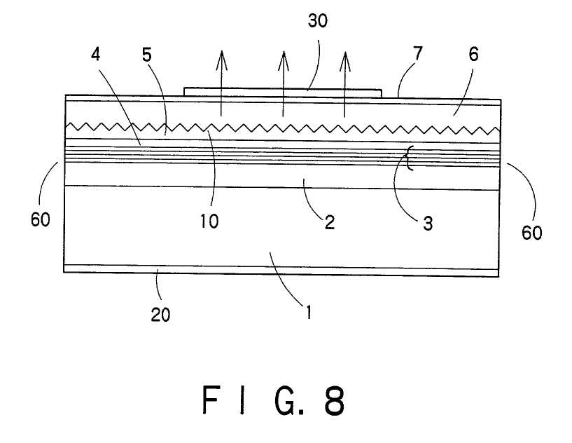

This laser device can be manufactured substantially in the same manner as explained before with reference to FIG. 8. So, the same components thereof as those of FIG. 8 are labeled with common reference numerals, and their detailed explanation is omitted.

1st-order gratings and 2nd-order gratings are typically used in DFB lasers. The 1st order gratings have 1st order periods corresponding to oscillation wavelengths. The period of 2nd-order gratings are double of period of 1st-order gratings, and they can be made easily. For example, in case of an InGaAsP/InP DFB laser for the wavelength region of 1.3 μm, 1st-order gratings have the period of approximately 0.2 μm. Processing accuracy required therefor is as strict as 0.1 nm, and their control in depth is also tight. In contrast, period of 2nd-order gratings is 0.4 μm, and their fabrication is much easier. Additionally, 2nd-order gratings generated a radiation mode. In the laser shown in FIG. 2, radiation mode light can be obtained from the p-side surface of the device.

Moreover, in the present invention, side surfaces 60′ of the device including edges of the active layer 3 and the waveguide layer 5 are configured to slant relative to the major surface of the substrate 1. That is, side surfaces 60′ are not cleaved surfaces but are processed to be aslant. These slants can be made, for example, by configuring both these side surfaces to define certain crystalline planes ((111)-oriented) by using a Br in methanol wet etchant. With this aslant facet structure, undesirable horizontal resonance by reflection from edges can be restricted. If an anti-reflection (AR) coating 70 in form of a dielectric thin film with the thickness of λ/4 (λ: oscillation wavelength) is coated onto the slant edges, then the reflectance can be readily reduced to 0.1%.

In ordinary edge emitting lasers, cleaved surfaces normal to the waveguide extending direction are required as their edges in order to return reflected light from at least one edge into the waveguide. Unlike such conventional edge emitting lasers, the invention realizes unique GCSEL with both edges including the active layer being slanted, and attains great effects.

Next explained is the third embodiment of the invention.

FIG. 3 is a cross-sectional view schematically showing a surface emitting laser according to the third embodiment of the invention. Here again, the laser is an example in which the invention is applied to a InGaAlP/GaAs-based surface emitting DFB laser using 2nd-order gratings (GCSEL).

The laser shown here has a similar structure as that of the laser explained above with reference to FIG. 2. That is, the laser shown here includes an n-type cladding layer 2 made of InGaAlP (Al composition: 0.7), active layer 3 with a MQW structure of InGaP/InGaAlP, cladding layer 4 of p-type InGaAlP (Al composition: 0.7), and waveguide layer 5 of p-type InGaAlP (Al composition: 0.2) which are stacked in this order on an n-type GaAs substrate 1. 2nd-order gratings 10 grooved formed along the surface of the waveguide layer 5. Their period may be, for example, approximately 0.2 μm. Further stacked on the gratings 10 are a cladding layer 6 made of p-type InGaAlP (Al composition: p.7) and a current diffusion layer 7 made of p-type InGaP.

Additionally, an n-side electrode 20 and a p-side electrode 30 are made on and under the device. The p-side electrode may be made of ITO (indium tin oxide) having both an optical transmittance and an electric conductivity. Thus, radiation mode outputs can be obtained from the gratings 10 through the p-side electrode 30.

This laser device can be manufactured substantially in the same manner as explained before with reference to FIG. 8. So, the same components thereof as those of FIG. 8 are labeled with common reference numerals, and their detailed explanation is omitted.

In this embodiment, both side surfaces 60″ of the device including the active layer 3 are slanted in the same direction. This structure can be realized by using a so-called “off-axis substrate”. For example, a substrate having a major surface with a surface orientation slanted by 15° from the {100}-oriented plane toward the waveguide may be used as the GaAs substrate 1. The cladding layer 2, active layer 3, and so forth, are sequentialy grown on the “off-axis substrate” by the process explained above. Then, the edges are made by cleavage. Since these cleaved surfaces typically have a {011} surface orientation, edges slanted by 15° relative to the major surface of the substrate 1 can be obtained.

The Inventor made reviews on “off-angles” of substrate surface orientation, i.e. slanted angles of edges. As a result, it has been confirmed that “off angles” not less than 3° remarkably suppress undesirable resonance by reflection from edges. Further, if an anti-reflection coating 70 of a dielectric thin film with the thickness of λ/4 on to the slanted edges, then reflectance is readily reduced to 0.1% or less, and reflection from edges is further reduced.

In typical edge emitting lasers, edges are required to have cleaved edges normal to the substrate surface. Therefore, even when using an “off-axis substrate”, the direction of the “off angle” is taken on a direction normal to the waveguide direction. In contrast, the structure taking the “off angle” direction on a direction parallel to the waveguide direction is unique, and its effects are peculiar to surface emitting lasers (GCSEL).

The 2nd-order grating 10 also have an asymmetric cross-sectional configuration between left and right sides in accordance with the “off angle” of the substrate to form gratings with a so-called blaze angle.

In asymmetric 2nd- or higher-order gratings, i.e., DFB lasers using grating with a blaze angle, the gain/loss coupling effects are added through the process of optical coupling generating a radiation mode even when actually having no periodic structure for gains and losses, as set forth after Equation (27) of p. 137 of a literature by Streifer et al. (W. Streifer et al, “Coupled Wave Analysis of DFB and DBR Lasers”, IEEE Journal of Quantum Electronics, vol. QE13, pp. 134-141, 1977).

Gratings are a periodic structure of a refractive index, and a periodic structure of the real part of the complex refractive index. Gain/loss coupling is a feedback of light by a periodic structure of the imaginary number part. If the gratings are asymmetric between left and right sides, rightward guided light and leftward guided light are different in effect of their generation in the process of generating a radiation mode. Such differences are considered to make periodic distribution of radiation mode losses.

The gain/loss periodic structure has the effect of forcibly stabilizing the longitudinal mode as a standing wave, and it is advantageous for oscillation of single longitudinal modes.

One of other effects is that the optical coupling efficiency is improved, in general. The above-introduced literature shows Table 1 on p. 138. With a blaze angle, the absolute value of the coupling coefficient Kp increases. Although the real part decreases and the imaginary number part increases, the absolute value increases.

That is, even with shallow gratings, a large coupling is obtained.

This means that, when gratings are developed to spatial higher harmonics, odd function components, instead of even function components, increase. Since spatial higher harmonic components in concern with coupling increase, coupling becomes efficient.

In this manner, employment of a slanted substrate according to this embodiment facilitates realization both lower reflection of edges and improvement of single longitudinal modes.

In the example shown in FIG. 3, the “off angle” of the substrate is parallel to the waveguide direction. However, the invention is not limited to it. That is, the “off angle” of the substrate may be aslant from the waveguide direction, instead of being parallel or normal. Even then, edges of the element can be slanted, and various effects explained with reference to FIG. 3 are still ensured.

Next explained is the fourth embodiment of the invention.

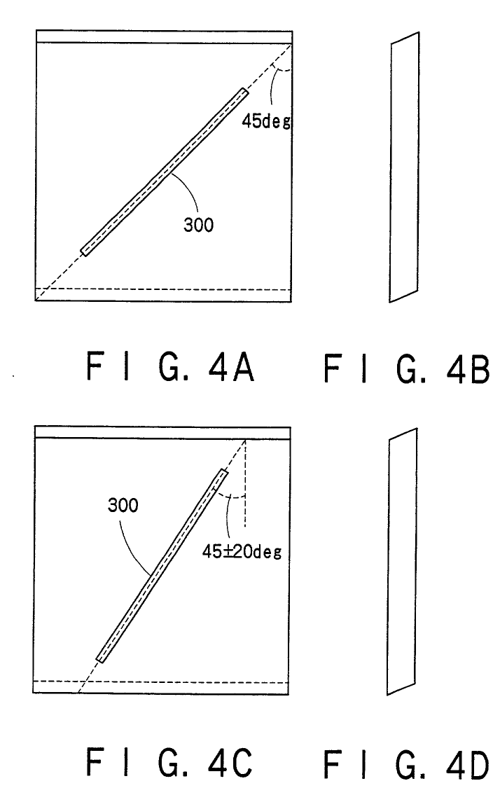

FIGS. 4a through 4D are schematic diagrams of surface emitting lasers according to the forth embodiment. FIGS. 4A and 4C are plan views of examples in which the invention is applied to surface emitting DFB lasers using 2nd-order gratings, respectively. FIGS. 4B and 4D are their side elevational views.

The embodiment shown here is also based on the concept of the invention, namely, edges of the active layer being offset from the perpendicular plane. Since GCSEL originally needs no edges, the direction of the waveguide 300 need not be normal to the cleaved surfaces. Rather, if the waveguide 300 is normal to the cleaved surfaces, the cavity length cannot be maximized in case of a device having a rectangular configuration. Also taking account of non-exited portions, for example, the element size will become bulky to the contrary.

Putting cleaved surfaces outside from consideration, it is efficient to take the direction of the stripe of the waveguide on the diagonal direction of a square-shaped element as shown in FIGS. 4A and 4B because the maximum cavity length can be obtained (2½ times the length vertical to the cleaved surfaces). Also in a rectangular element, a diagonal direction is the longest direction.

However, if it makes 45° relative to the cleaved surfaces, side surfaces or edges of the stripe may undesirably become upright by etching. Additionally, comers of the device may be removed by etching to form vertical surfaces because planes offset by 45° from the cleaves surfaces result in being crystallographically oriented by etching just to the intermediate orientation between the orientation forming the mesa stripe with trapezoid cross-section and the orientation forming the mesa, stripe with inverted trapezoid cross-section.

Therefore, the direction of the stripe is more preferably offset from the direction of 45° from the cleaved surfaces. When the stripe direction is offset from the 45° direction relative to the cleaved surfaces in this manner, side surfaces and edges of the stripe is offset from the plane normal to the substrate surface. According to researches by the Inventor, if the stripe is made to be offset by ±20, for example, from 45° relative to the cleaved surfaces, a more desirable device can be made, in which the stripe can be elongated by effectively using the device area, and room for selection whether to make side surfaces or edges of the stripe closer toward the trapezoidal mesa or the inverted mesa is enlarged. That is, by decreasing the element size, and inclining edges of the waveguide stripe by a predetermined angle, various effects as explained above can be obtained. It is also possible to prevent the edges from becoming vertical planes by etching.

Next explained is the fifth embodiment of the invention.

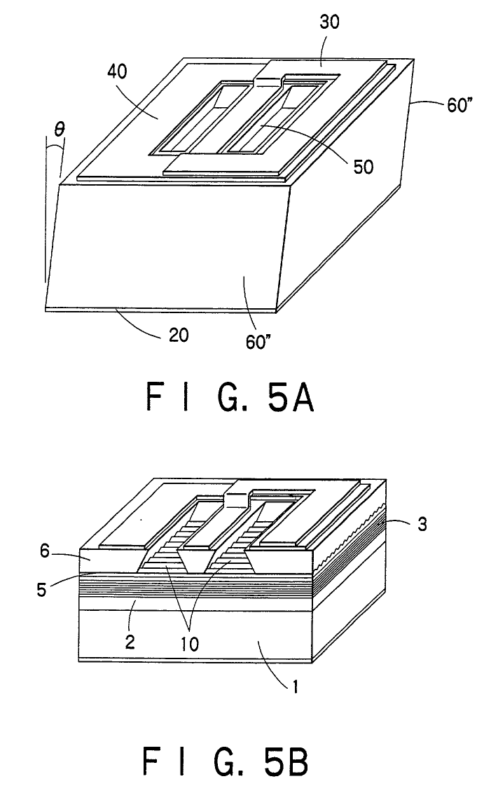

FIGS. 5A and 5B are diagrams schematically showing a surface emitting laser according to the fifth embodiment of the invention. FIG. 5a is a perspective of the entirety of an example applying the invention to a surface emitting DFB laser (GCSEL) using 2nd-order gratings, and FIG. 5B is a perspective view of a part cut out from it. GCSEL shown here is a surface emitting laser having a so-called “ridge type waveguide”. Sequentially stacked on the n-type GaAs substrate 1 are an n-type cladding layer 2 of InGaAlP, active layer 3 having a MQW structure of InGaP/InGaAlP and waveguide layer 5 of p-type InGaAlP. 2nd-order gratings 10 are formed along the surface of the waveguide layer 5. Their period may be approximately 0.2 μm, for example. Further stacked on the gratings 10 is a cladding layer made of p-type InGaAlP.

The cladding layer 6 is selectively removed by patterning to form a ridge stripe 50 in a central part of the device. The device has the n-side electrode 20 and the p-side electrode 30 on its top and bottom surfaces, respectively. On the p-side, a SiO₂ film 40 and the p-side electrode 30 of ITO are selectively made, and radiation mode outputs can be obtained from the gratings 10. In the portion other than the ridge stripe 50, the p-side electrode 30 made of ITO is insulated from the underlying semiconductor layer by the SiO₂ film 40.

Since GCSEL is a surface emitting element not requiring edges, opposite ends of the waveguide need not be terminated by the upright facet On the other hand, in conventional elements having a so-called ridge type waveguide, when a ridge stripe having a convex and stepped cross-sectional configuration exists on edges, it causes the problems that a step makes smooth cleavage difficult, and an electrode must be made with step-coverage, which makes fabrication of the element difficult.

In case of GCSEL in which the ridge waveguide need not be made near edges of the device, the ridge stripe may be made solely in a central part of the element. In GCSEL shown here, the transparent electrode (ITO) 30 is in contact only with the ridge stripe 50 formed in a central part of the device. Near the edges of the element, the transparent electrode 30 is insulated by the SiO₂ film 40. That is, excitation does not occur near the edges, but occurs solely in a central part of the element.

Electrical connection from components other than the ridge stripe 50 may be made through flat portions near the edges. Additionally, when the ridge stripe 50 is configured as an inverted mesa, the contact area for the p-side electrode 30 can be enlarged, and the current injection region can be narrowed.

In the illustrated example, the cladding layer 6 is patterned to form the ridge stripe 50. However, the ridge stripe may be made by patterning the waveguide layer 5 as well.

Also in the embodiment shown here, since the substrate surface is slanted by 15° from the (100) plane, edges 60″ of the element including the active layer 3 are cleaved aslant in accordance with the inclination of the substrate surface. Therefore, the same effect as those of the other embodiments can be ensured regarding suppression of resonance parallel to the surface in the active layer 3.

Moreover, since the gratings 10 also have a blaze angle, it is advantageous for oscillation in the single longitudinal mode. Furthermore, side surfaces of the ridge stripe 50 are configured as an inverted-trapezoid mesa, with a wide top width and a narrower bottom width. That is, it can be configured so that, for the active layer, the current and the transverse mode are confined, and the electrode contact is widely reserved to facilitate making contact.

Although FIGS. 5A and 5B show an example in which the ridge stripe 50 is made to extend normally to the cleaved surfaces of the element, the invention is not limited to it. That is, as shown in FIGS. 4A through 4D, the ridge stripe may be made to have an offset angle of 45° or any other appropriate angle relative to the cleaved surfaces of the device. In this manner, the embodiment shown in FIGS. 5a and 5B will ensure various effects explained with reference to FIGS. 4A through 4D as well.

Next explained is a semiconductor light emitting device according to the invention.

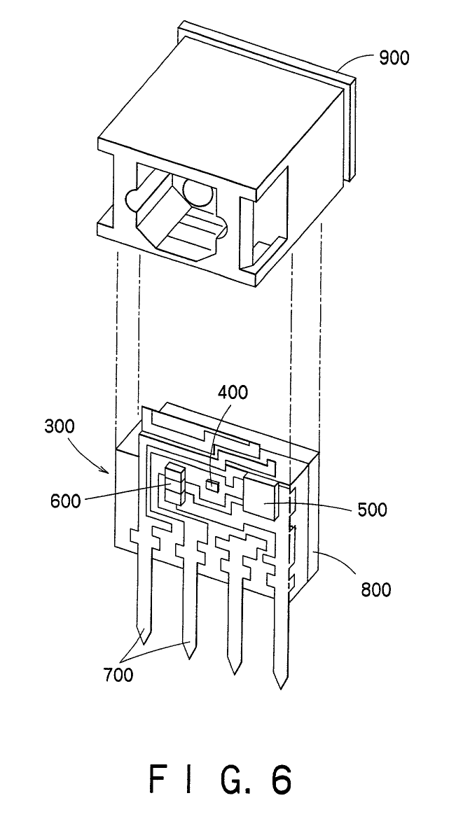

FIG. 6 is a diagram schematically showing a semiconductor light emitting device according to an embodiment of the invention. This is an optical transmission module incorporating one of lasers according to the foregoing embodiments. Surface emitting lasers are advantageous in permitting molding by an encapsulating resin unlike edge emitting lasers.

The optical transmission module shown here includes an optical transmission unit 300 and a receptacle 900. The optical transmission unit 300 is made by mounting a surface emitting laser 400 according to one of the foregoing embodiments of the invention, a transmitting IC 500 incorporating laser driving circuits into a single chip, and a chip capacitor 600 on a lead frame 700 used as a supporting member and by molding them with a transparent encapsulating resin 800. The receptacle 900 is brought into engagement to cover the central part of the optical transmission nit 300, and it functions as a case for coupling the optical transmission unit 300 and an optical connector, not shown. In this example, the encapsulating resin 800 or the receptacle 900 functions as a packaging member.

The surface emitting laser 400 used here is one for a wavelength suitable for a low-loss region of an optical fiber used here. Additionally, according to the invention, a surface emitting laser excellent in oscillation property as explained with reference to the foregoing embodiments can be obtained. Therefore, even when molded with a resin 800 such as epoxy, for example, its property is not changed, and an optical transmission module as inexpensive as LED (light emitting diode) and having a much higher performance can be realized.

The surface emitting lasers according to the invention can be encapsulated with a resin in any mode not limited to the example shown in FIG. 6, and they can be readily mounted on various type of lead frames, stems, packaging substrates, or the like, for wider use in various applications.

Embodiments of the invention have been explained above with reference to some examples. However, the invention is not limited to these examples.

For example, the invention ensures the same effects also when used surface emitting lasers made of various materials, such as GaAlAs lasers, GaInAsP laser, InGaAlP laser and InGaAlN lasers.

Moreover, the same effects are ensured when employing any known structures usable by the skilled in the art as the multi-layered structure of the surface emitting laser.

While the present invention has been disclosed in terms of the preferred embodiment in order to facilitate better understanding thereof, it should be appreciated that the invention can be embodied in various ways without departing from the principle of the invention. Therefore, the invention should be understood to include all possible embodiments and modification to the shown embodiments which can be embodied without departing from the principle of the invention as set forth in the appended claims.

What is claimed is:

1. A surface emitting laser comprising:
a semiconductor substrate; and
an active layer made on a first major surface of said semiconductor substrate, so that light output from said active layer be obtained in a direction substantially normal to said major surface of said substrate,
said active layer having side surfaces which are offset from vertical planes normal to said major surface of said semiconductor substrate to prevent in-plane horizontal resonance of light in said active layer.

2. The surface emitting laser according to claim 1 further comprising:
a first optical reflector interposed between said semiconductor substrate and said active layer; and
a second optical reflector provided on a superstrate side of said active layer,
all side surfaces of said active layer being offset from vertical planes normal to said major surface.

3. The surface emitting laser according to claim 1 wherein said semiconductor substrate and said active layer are made of semiconductors having a zinc blend structured crystalline structure,
said first major surface of said semiconductor substrate having a surface orientation parallel to the {100} plane,
said side surfaces of said active layer having a surface orientation parallel to the {111} plane.

4. The surface emitting laser according to claim 1 wherein said semiconductor substrate and said active layer are made of semiconductors having a zinc blend structured crystalline structure,
said first major surface of said semiconductor substrate having a surface orientation slanted by an angle not less than 3° from the {100} plane,
said side surfaces of said active layer having a surface orientation parallel to the {011} plane.

5. The surface emitting laser according to claim 4 wherein said side surface of said active layer are made by cleavage.

6. The surface emitting laser according to claim 1 wherein an anti-reflection a dielectric thin film is coated onto said side surface of said active layer.

7. The surface emitting laser according to claim 1 further comprising:
a waveguide layer provided on said major surface of said semiconductor substrate and having formed 2nd-order gratings along the waveguide direction,
facets of said active layer and facets of said waveguide layer at opposite ends in the waveguide direction being offset from vertical planes normal to said first major surface of said substrate.

8. The surface emitting laser according to claim 7 wherein said semiconductor substrate, said active layer and said waveguide layer are made of semiconductors having a zinc blend structured crystalline structure,
said first major surface of said semiconductor substrate having a surface orientation parallel to the {100} plane,
said facets of said active layer and said faces of said waveguide layer having a surface orientation parallel to the {111} plane.

9. The surface emitting laser according to claim 7 wherein said semiconductor substrate, said active layer and said waveguide layer are made of semiconductors having a zinc blend structured crystalline structure,
said first major surface of said semiconductor substrate having a surface orientation slanted by an angle not less than 3° from the {100} plane,
said facets of said active layer and said faces of said waveguide layer having a surface orientation parallel to the {011} plane.

10. The surface emitting laser according to claim 9 wherein said facets of said active layer and said facets of said waveguide layer are made by cleavage.

11. The surface emitting laser according to claim 7 further comprising:
a cladding layer provided on said waveguide layer; and
an electrode provided on said cladding layer,
said cladding layer being selectively made in a central part of said laser to form a ridge stripe,
said electrode being electrically connected above said ridge stripe but electrically insulated near facets at opposite ends of said ridge stripe.

12. The surface emitting laser according to claim 11 wherein said semiconductor substrate, said active layer and said waveguide layer are made of semiconductors having a zinc blend structured crystalline structure,
said first major surface of said semiconductor substrate having a surface orientation parallel to the {100} plane,
said facets of said active layer and said facets of said waveguide layer having a surface orientation parallel to the {111} plane.

13. The surface emitting laser according to claim 11 wherein said semiconductor substrate, said active layer and said waveguide layer are made of semiconductors having a znc blend structured crystalline structure,
said first major surface of said semiconductor substrate having a surface orientation slanted by an angle not less than 3° from the {100} plane,
said facets of said active layer and said faces of said waveguide layer having a surface orientation parallel to the {011} plane.

14. The surface emitting laser according to claim 13 wherein said facets of said active layer and said facets of said waveguide layer are made by cleavage.

15. The surface emitting laser according to claim 7 wherein said 2nd-order gratings have a asymmetric cross-sectional configuration.

16. The surface emitting laser according to claim 7 wherein an anti-reflection coating of a dielectric thin film is applied onto said facets of said active layer.

17. A surface emitting laser comprising:
a semiconductor substrate;
an active layer provided on a first major surface of said semiconductor substrate; and
a waveguide layer provided on said first major surface of said semiconductor substrate and having formed 2nd-order gratings along the waveguide direction, so as to obtain output light in a direction substantially normal to said first major surface of said semiconductor substrate,
said laser having a substantially rectangular element configuration when viewed from a direction normal to said first major surface of said semiconductor substrate,
any of side surfaces of said substantially rectangular element being cleaved surfaces;
said cleaved surfaces being offset from vertical planes normal to said first major surface,
said waveguide direction being not parallel with any of sides of the substantial rectangle.

18. The surface emitting laser according to claim 17 wherein said waveguide direction being offset by an angle other than 45° from any of the sides of the substantial rectangle.

19. The surface emitting laser according to claim 17 wherein said 2nd-order gratings have a asymmetric cross-sectional configuration.

20. A semiconductor light emitting device comprising:
a supporting member;
a surface emitting laser mounted on said supporting member; and
a packaging member enveloping said surface emitting laser,
said surface emitting laser including:
a semiconductor substrate; and
an active layer made on a first major surface of said semiconductor substrate, so that light output from said active layer be obtained in a direction substantially normal to said major surface of said substrate,
said active layer having side surfaces which are offset from vertical planes relative to said major surface of said semiconductor substrate to prevent in-plane resonance of light in said active layer.
